(19) United States
(12) Patent Application Publication
(10) Pub. No.: US 2017/0353898 A1
(43) Pub. Date: Dec. 7, 2017

(54) SYSTEMS AND METHODS FOR REGULATING THERMAL PERFORMANCE OF A USER EQUIPMENT

(71) Applicant: QUALCOMM Incorporated, San Diego, CA (US)

(72) Inventors: Vishnu Namboodiri Karakkad Kesavan Namboodiri, Hyderabad (IN); Mukesh Kumar, Hyderabad (IN); Suresh Sanka, Hyderabad (IN); Nilotpal Dhar, Hyderabad (IN)

(21) Appl. No.: 15/175,366

(22) Filed: Jun. 7, 2016

(51) Int. Cl. H04W 36/14; G06F 11/30; G06F 11/34; H04L 1/16; H04W 36/22; H04W 88/06

(52) U.S. Cl. CPC H04W 36/14; H04L 1/16; H04W 36/22; G06F 11/3024; G06F 11/3433; H04W 88/06

(57) ABSTRACT

According to various embodiments, there is provided a method for a wireless communication device having at least one Subscriber Identity Module (SIM) associated with a subscription to manage communications over the subscription. The method may include determining a value of a computer processing unit (CPU) load of the wireless communication device, the CPU load based on data operations of the at least one SIM and contributing to a thermal state of the wireless communication device. The method may further include determining whether the value of the CPU load is greater than a load threshold. The method may further include, in response to determining that the value of the CPU load is greater than the load threshold, performing a variable tuneaway at the at least one SIM during which the at least one SIM is configured to halt the data operations, a length of the variable tuneaway based on the value of the CPU load.

### BACKGROUND

A user equipment or wireless communication device, such as a mobile phone device or a smart phone, may include two or more Subscriber Identity Modules (SIMs). Each SIM may correspond to at least one subscription via a Radio Access Technology (RAT). Such a wireless communication device may be a multi-SIM wireless communication device. In a Multi-SIM-Multi-Active (MSMA) wireless communication device, all SIMs may be active at the same time. In a Multi-SIM-Multi-Standby (MSMS) wireless communication device, if any one SIM is active, then the rest of the SIM(s) may be in a standby mode. The RATs may include, but are not limited to, Frequency Division Multiple Access (FDMA), Time Division Multiple Access (TDMA), Code Division Multiple Access (CDMA) (particularly, Evolution-Data Optimized (EVDO)), Universal Mobile Telecommunications Systems (UMTS) (particularly, Wideband Code Division Multiple Access (WCDMA), Long Term Evolution (LTE), and the like), Global System for Mobile Communications (GSM), Code Division Multiple Access 1× Radio Transmission Technology (lx), General Packet Radio Service (GPRS), Wi-Fi, Personal Communications Service (PCS), and other protocols that may be used in a wireless communications network or a data communications network.

In multi-SIM devices (as well as single-SIM devices), hardware architecture has become smaller (e.g., including smaller printed circuit boards (PCBs)), which has led to more concentrated power densities. Furthermore, devices perform increasingly heavier application processing (e.g., multimedia rich applications such as 4K or 1080p video encoding). Accordingly, devices have exhibited an increase in thermal issues that result in overheating of electrical components.

### SUMMARY

The present disclosure is related to systems and method for regulating thermal performance of a user equipment. In various aspects, overheating of a user equipment may be mitigated. According to various embodiments, data flow control systems and processes of a wireless communication device reduce power consumption during overload periods, and quickly increase the throughput after the electrical load is suitably reduced.

According to various aspects, there is provided a method for a wireless communication device having at least one Subscriber Identity Module (SIM) associated with a subscription to manage communications over the subscription. The method includes determining a value of a computer processing unit (CPU) load of the wireless communication device, the CPU load based on data operations of the at least one SIM and contributing to a thermal state of the wireless communication device. The method further includes determining whether the value of the CPU load is greater than a load threshold. The method further includes, in response to determining that the value of the CPU load is greater than the load threshold, performing a variable tuneaway at the at least one SIM during which the at least one SIM is configured to halt the data operations, a length of the variable tuneaway based on the value of the CPU load.

In some aspects, the length of the variable tuneaway is proportional to the value of the CPU load.

In some aspects, the method further includes receiving a data packet during a first interval, and in response to determining that the value of the CPU load is greater than the load threshold, transmitting a negative acknowledgement (NACK) signal corresponding to the data packet received during the first interval.

In some aspects, the method further includes decoding the data packet received during the first interval before transmitting the NACK signal.

In some aspects, the method further includes receiving the data packet during a second interval, the data packet received during the second interval being the same as the data packet received during the first interval, and, in response to receiving the data packet during the second interval, transmitting an acknowledgement (ACK) signal corresponding to the data packet received during the second interval.

In some aspects, the method further includes receiving a plurality of consecutive data packets during a plurality of consecutive respective intervals, and, in response to determining that the value of the CPU load is greater than the load threshold, transmitting a plurality of consecutive negative acknowledgement (NACK) signals corresponding to the plurality of the consecutive respective intervals.

In some aspects, the method further includes decoding each of the consecutive data packets received during the plurality of consecutive respective intervals before transmitting the plurality of consecutive NACK signals.

In some aspects, the method further includes receiving the plurality of consecutive data packets during a plurality of subsequent consecutive respective intervals, the plurality of consecutive respective intervals being different from the plurality of subsequent consecutive respective intervals, and, in response to receiving the plurality of consecutive data packets during the plurality of subsequent consecutive respective intervals, transmitting a plurality of consecutive acknowledgement (ACK) signals corresponding to the plurality of subsequent consecutive respective intervals.

In some aspects, a number of the plurality of consecutive NACK signals equals a number of the plurality of consecutive data packets received during the plurality of consecutive respective intervals.

In some aspects, the receiving the plurality of consecutive data packets during the plurality of consecutive respective intervals includes receiving six consecutive data packets during six consecutive respective intervals, and the transmitting the plurality of consecutive NACK signals includes transmitting six consecutive NACK signals corresponding to the six consecutive respective intervals.

In some aspects, the at least one SIM includes an active SIM and an idle SIM, and the CPU load is based on the data operations of the active SIM and idle operations of the idle SIM.

In some aspects, the load threshold is a fixed value.

In some aspects, the load threshold is a variable value.

According to various aspects, a wireless communication device includes a processor connected to at least one Subscriber Identity Module (SIM) associated with a subscription, the processor configured to: determine a value of a computer processing unit (CPU) load of the wireless communication device, the CPU load based on data operations of the at least one SIM and contributing to a thermal state of the wireless communication device. The processor further configured to determine whether the value of the CPU load is greater than a load threshold. The processor further configured to, in response to determining that the value of the CPU load is greater than the load threshold, performing a variable tuneaway at the at least one SIM during which the at least one SIM is configured to halt the data operations, a length of the variable tuneaway based on the value of the CPU load.

In some aspects, the processor is further configured to receive a data packet during a first interval, and, in response to determining that the value of the CPU load is greater than the load threshold, transmit a negative acknowledgement (NACK) signal corresponding to the data packet received during the first interval.

In some aspects, the processor is further configured to receive the data packet during a second interval, the data packet received during the second interval being the same as the data packet received during the first interval, and, in response to receiving the data packet during the second interval, transmit an acknowledgement (ACK) signal corresponding to the data packet received during the second interval.

In some aspects, the processor is further configured to receive a plurality of consecutive data packets during a plurality of consecutive respective intervals, and, in response to determining that the value of the CPU load is greater than the load threshold, transmit a plurality of consecutive negative acknowledgement (NACK) signals corresponding to the plurality of the consecutive respective intervals.

In some aspects, the processor is further configured to receive the plurality of consecutive data packets during a plurality of subsequent consecutive respective intervals, the plurality of consecutive respective intervals being different from the plurality of subsequent consecutive respective intervals, and, in response to receiving the plurality of consecutive data packets during the plurality of subsequent consecutive respective intervals, transmit a plurality of consecutive acknowledgement (ACK) signals corresponding to the plurality of subsequent consecutive respective intervals.

### BRIEF DESCRIPTION OF THE DRAWINGS

The accompanying drawings, which are incorporated herein and constitute part of this specification, illustrate exemplary embodiments of the disclosure, and together with the general description given above and the detailed description given below, serve to explain the features of the various embodiments.

FIG. 1 is a schematic diagram of a communication system in accordance with various embodiments.

FIG. 2 is a component block diagram of an example of a wireless communication device according to various embodiments.

FIGS. 3A and 3B are process flowchart diagrams illustrating examples of methods for regulating thermal performance of a wireless communication device according to various embodiments.

FIG. 4 is a process flowchart diagram illustrating an example of a method for implementing variable tuneaway at a wireless communication device according to various embodiments.

FIG. 5A is a block diagram illustrating transmission of data packets between a network and a wireless communication device.

FIG. 5B is a process flowchart diagram illustrating an example of a method for implementing variable tuneaway at a wireless communication device according to various embodiments.

FIG. 6A is a process flowchart diagram illustrating an example of a method for implementing variable tuneaway at a wireless communication device according to various embodiments.

FIG. 6B is a block diagram illustrating transmission of data packets between a network and a wireless communication device.

FIG. 7 is a component block diagram of a wireless communication device suitable for use with various embodiments.

### DETAILED DESCRIPTION

Various embodiments will be described in detail with reference to the accompanying drawings. Wherever possible, the same reference numbers may be used throughout the drawings to refer to the same or like parts. Different reference numbers may be used to refer to different, same, or similar parts. References made to particular examples and implementations are for illustrative purposes, and are not intended to limit the scope of the disclosure or the claims.

Some modern communication devices, referred to herein as a wireless communication device, User Equipment (UE), or Mobile Station (MS), may include any one or all of cellular telephones, smart phones, personal or mobile multi-media players, personal data assistants, laptop computers, personal computers, tablet computers, smart books, palm-top computers, wireless electronic mail receivers, multimedia Internet-enabled cellular telephones, wireless gaming controllers, and similar personal electronic devices. Such a wireless communication device may include at least one Subscriber Identity Module (SIM), a programmable processor, memory, and circuitry for connecting to two or more mobile communication networks.

A wireless communication device may include one or more SIMs that provide users of the wireless communication devices with access to one or multiple separate mobile communication networks. The mobile communication networks may be supported by Radio Access Technologies (RATs). The wireless communication device may be configured to connect to one or more base stations via one or more RATs. Examples of RATs may include, but not limited to, Frequency Division Multiple Access (FDMA), Time Division Multiple Access (TDMA), Code Division Multiple Access (CDMA) (particularly, Evolution-Data Optimized (EVDO)), Universal Mobile Telecommunications Systems (UMTS) (particularly, Wideband Code Division Multiple Access (WCDMA), Long Term Evolution (LTE), and the like), Global System for Mobile Communications (GSM), Code Division Multiple Access 1× Radio Transmission Technology (lx), General Packet Radio Service (GPRS), Wi-Fi, Personal Communications Service (PCS), and other protocols that may be used in a wireless communications network or a data communications network. Each RAT may be associated with a subscription or SIM.

A wireless communication device provided with a plurality of SIMs and connected to two or more subscriptions or networks with one subscription or network being active at a given time is a Multi-SIM-Multi-Standby (MSMS) communication device. In one example, the MSMS communication device may be a Dual-SIM-Dual-Standby (DSDS) communication device, which may include two SIMs that may both be active on standby, but one is deactivated when the other one is in use. In another example, the MSMS communication device may be a Triple-SIM-Triple-Standby (TSTS) communication device, which includes three SIMs that may all be active on standby, where two may be deactivated when the third one is in use. In other examples, the MSMS communication device may be other suitable multi-SIM communication devices, with, for example, four or more SIMs, such that when one is in use, the others may be deactivated.

On the other hand, a wireless communication device that includes a plurality of SIMs and connects to two or more subscriptions or networks with two or more subscriptions or networks being active at a given time may be a MSMA communication device. An example MSMA communication device may be a Dual-SIM-Dual-Active (DSDA) communication device, which may include two SIM. Both SIMs may remain active. In another example, the MSMA device may be a Triple-SIM-Triple-Active (TSTA) communication device, which may include three SIM. All three SIMs may remain active. In other examples, the MSMA communication device may be other suitable multi-SIM communication devices with four or more SIMs, all of which may be active.

Generally, embodiments described herein may be applicable to a MSMS wireless communication device having at least a first SIM and a second SIM. Illustrating with a non-limiting example, the first SIM may be associated with a first subscription via a first RAT, and the second SIM may be associated with a second subscription via a second RAT. The embodiments may also be applicable to a MSMA wireless communication device that halts first subscription communication activities due to blanking pattern, power back-off, interference, and/or the like when the second subscription receives pages or other types of communication.

As used herein, the terms “SIM,” “SIM card,” and “subscriber identification module” may be used interchangeably to refer to a memory that may be an integrated circuit or embedded into a removable card, and that stores an International Mobile Subscriber Identity (IMSI), related key, and/or other information used to identify and/or authenticate a wireless device on a network and enable communication services with the network. Because the information stored in a SIM may be information used by the wireless device for establishing a communication link for a particular communication service with a particular network, the term “SIM” may also be used herein as a shorthand reference to the communication service (e.g., the networks, the subscriptions, the services, and/or the like) associated with and enabled by the information (e.g., in the form of various parameters). The information may be stored in a particular SIM as the SIM and the communication network, as well as the services and RATs supported by that network, correlate with one another.

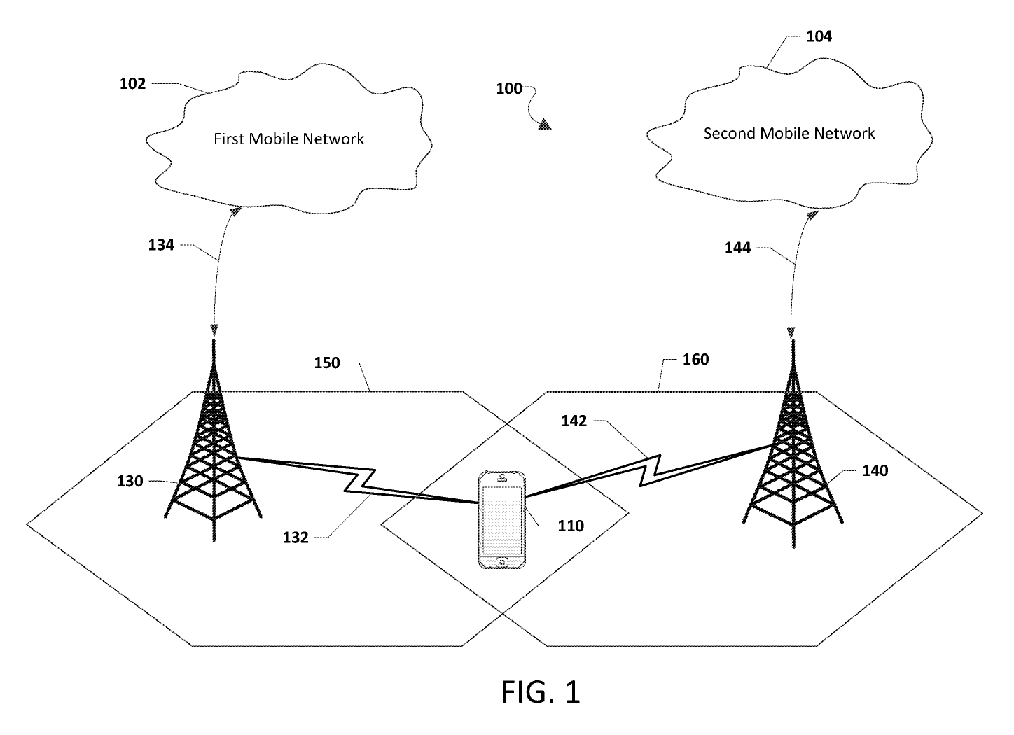

Various embodiments may be implemented within a communication system 100, an example of which is illustrated in FIG. 1. Referring to FIG. 1, a first mobile network 102 and a second mobile network 104 may each associate with a plurality of cellular base stations (e.g., a first base station 130 and a second base station 140, respectively). The first base station 130 may broadcast the first mobile network 102 in a first serving cell 150. The second base station 140 may broadcast the second mobile network 104 in a second serving cell 160. A wireless communication device 110 may be associated with (within effective boundaries of) both the first serving cell 150 and the second serving cell 160.

The wireless communication device 110 may be in communication with the first mobile network 102 through a first cellular connection 132 to the first base station 130. The first cellular connection 132 may correspond to the first RAT of the wireless communication device 110. The wireless communication device 110 may also be in communication with the second mobile network 104 through a second cellular connection 142 to the second base station 140. The second cellular connection 142 may correspond to the second RAT of the wireless communication device 110, as in a multi-SIM context. The first base station 130 may be in communication with the first mobile network 102 over a wired or wireless connection 134. The second base station 140 may be in communication with the second mobile network 104 over a wired or wireless connection 144.

The first cellular connection 132 and the second cellular connection 142 may be made through two-way wireless communication links. Each of the wireless communication links may be enable by any suitable protocol including, but not limited to, FDMA, TDMA, CDMA (e.g., EVDO), UMTS (e.g., WCDMA, LTE, or the like), GSM, lx, GPRS, Wi-Fi, PCS, and/or another protocol used in a wireless communications network or a data communications network. By way of illustrating with a non-limiting example, the first cellular connection 132 may be an LTE connection. The second cellular connection 142 may be an LTE connection or any other suitable connection. Other RATs (such as, but not limited to, WCDMA, HSDPA, EVDO, and the like) may be implemented in a similar manner.

Each of the first base station 130 and the second base station 140 may include at least one antenna group or transmission station located in the same or different areas. The at least one antenna group or transmission station may be associated with signal transmission and reception. Each of the first base station 130 and the second base station 140 may include one or more processors, modulators, multiplexers, demodulators, demultiplexers, antennas, and the like for performing the functions described herein. In some embodiments, the first base station 130 and the second base station 140 may be an access point, Node B, evolved Node B (eNodeB or eNB), base transceiver station (BTS), or the like.

In various embodiments, the wireless communication device 110 may be configured to access the first mobile network 102 and the second mobile network 104 by virtue of the multi-SIM and/or the multi-mode SIM configuration of the wireless communication device 110 (e.g., via the first cellular connection 132 and the second cellular connection 142). When a SIM corresponding to a RAT is inserted, the wireless communication device 110 may access the mobile communication network associated with that RAT based on the information stored on the SIM through registrations and call setups.

While the wireless communication device 110 is shown connected to the mobile networks 102 and 104 via two cellular connections, in other embodiments (not shown), the wireless communication device 110 may establish additional network connections using at least one additional RAT.

In some embodiments, the wireless communication device 110 may establish a wireless connection with a peripheral device (not shown) used in connection with the wireless communication device 110. For example, the wireless communication device 110 may communicate over a Bluetooth® link with a Bluetooth-enabled personal computing device (e.g., a “smart watch”). In some embodiments, the wireless communication device 110 may establish a wireless connection with a wireless access point (not shown), such as over a Wi-Fi connection. The wireless access point may be configured to connect to the Internet or another network over a wired connection.

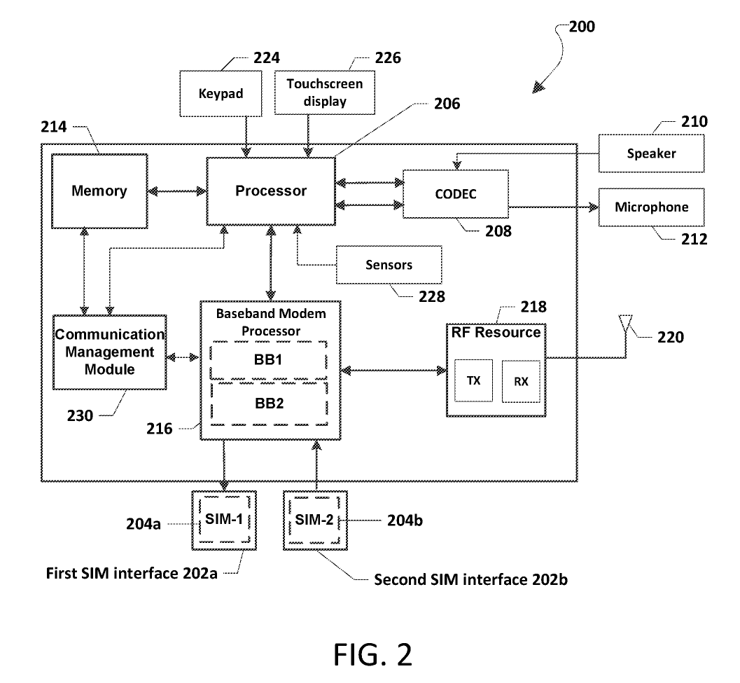

FIG. 2 is a functional block diagram of a wireless communication device 200 suitable for implementing various embodiments. According to various embodiments, the wireless communication device 200 may be the wireless communication device 110 as described with reference to FIG. 1. Referring to FIGS. 1-2, the wireless communication device 200 may include a first SIM interface 202a, which may receive a first identity module SIM-1 204a that is associated with the first mobile network 102. The wireless communication device 200 may also include a second SIM interface 202b, which may receive a second identity module SIM-2 204b that is associated with the second mobile network 104.

A SIM (e.g., SIM-1 204a, SIM-2 204b, and/or the like) in various embodiments may be a Universal Integrated Circuit Card (UICC) that is configured with SIM and/or Universal SIM (USIM) applications, enabling access to GSM and/or UMTS networks. The UICC may also provide storage for a phone book and other applications. Alternatively, in a CDMA network, a SIM may be a UICC removable user identity module (R-UIM) or a CDMA Subscriber Identity Module (CSIM) on a card. A SIM card may have a Central Processing Unit (CPU), Read Only Memory (ROM), Random Access Memory (RAM), Electrically Erasable Programmable Read-Only Memory (EEPROM) and Input/Output (I/O) circuits. An Integrated Circuit Card Identity (ICCID) SIM serial number may be printed on the SIM card for identification. However, a SIM may be implemented within a portion of memory of the wireless communication device 200, and thus need not be a separate or removable circuit, chip, or card.

A SIM used in various embodiments may store user account information, an IMSI, a set of SIM Application Toolkit (SAT) commands, and other network provisioning information, as well as provide storage space for phone book database of the user's contacts. As part of the network provisioning information, a SIM may store home identifiers (e.g., a System Identification Number (SID)/Network Identification Number (NID) pair, a Home PLMN (HPLMN) code, etc.) to indicate the SIM card network operator provider.

The wireless communication device 200 may include at least one controller, such as a general-purpose processor 206, which may be coupled to a coder/decoder (CODEC) 208. The CODEC 208 may in turn be coupled to a speaker 210 and a microphone 212. The general-purpose processor 206 may also be coupled to at least one memory 214. The general-purpose processor 206 may include any suitable data processing device, such as a microprocessor. In the alternative, the general-purpose processor 206 may be any suitable electronic processor, controller, microcontroller, or state machine. The general-purpose processor 206 may also be implemented as a combination of computing devices (e.g., a combination of a Digital Signal Processor (DSP) and a microprocessor, a plurality of microprocessors, at least one microprocessor in conjunction with a DSP core, or any other such configuration).

The memory 214 may be a non-transitory processor-readable storage medium that stores processor-executable instructions. For example, the instructions may include routing communication data relating to the first or second subscription though a corresponding baseband-RF resource chain. The memory 214 may include any suitable internal or external device for storing software and data. Examples of the memory 214 may include, but are not limited to, RAM, ROM, floppy disks, hard disks, dongles or other Recomp Sensor Board (RSB) connected memory devices, or the like. The memory 214 may store an Operating System (OS), user application software, and/or executable instructions. The memory 214 may also store application data, such as an array data structure.

The general-purpose processor 206 and the memory 214 may each be coupled to baseband modem processor 216. The SIMs (e.g., the SIM-1 204a, the SIM-2 204b, and/or the like) in the wireless communication device 200 may be associated with at least one baseband-RF resource chain. A baseband-RF resource chain may include the baseband modem processor 216, which may perform baseband/modem functions for communications on the SIMs. The baseband modem processor 216 may include one or more amplifiers and radios, referred to generally herein as a RF resource 218 or RF chain.

The embodiments described herein may be applicable to wireless communication devices in which the SIMs 204a and 204b share a common set of RF resource (particularly, the RF resource 218). Embodiments described herein may also be applicable to wireless communication devices in which each of the SIMs 204a and 204b has a separate RF resource, but activities of one of the SIMs 204a and 204b may be deactivated while the other one of the SIMs 204a and 204b is active.

The RF resource 218 may include at least one transceiver that perform transmit/receive functions for the associated SIMs 204a and 204b of the wireless communication device 200. The RF resource 218 may include separate transmit and receive circuitry, or may include a transceiver that combines transmitter and receiver functions. The RF resource 218 may be coupled to a wireless antenna 220. The RF resource 218 may also be coupled to the baseband modem processor 216.

In some embodiments, the general-purpose processor 206, the memory 214, the baseband modem processor 216, and the RF resource 218 may be included in the wireless communication device 200 as a system-on-chip. In some embodiments, the SIMs 204a and 204b and their corresponding interfaces 202a, 202b may be external to the system-on-chip. Further, various input and output devices may be coupled to components on the system-on-chip, such as interfaces or controllers. Example user input components suitable for use in the wireless communication device 200 may include, but are not limited to, a keypad 224, a touchscreen display 226, and the microphone 212.

In some embodiments, the keypad 224, the touchscreen display 226, the microphone 212, or a combination thereof, may perform the function of receiving a request to initiate an outgoing call. For example, the touchscreen display 226 may receive a selection of a contact from a contact list or receive a telephone number. In another example, either or both of the touchscreen display 226 and the microphone 212 may perform the function of receiving a request to initiate an outgoing call. For example, the touchscreen display 226 may receive a selection of a contact from a contact list or to receive a telephone number. As another example, the request to initiate the outgoing call may be in the form of a voice command received via the microphone 212. Interfaces may be provided between the various software modules and functions in the wireless communication device 200 to enable communication between them.

The wireless communication device 200 may include a communication management module 230. The communication management module 230 may configure the wireless communication device 200 to implement various software layers. For example, the communication management module 230 may implement a Media Access Control (MAC) layer, Radio Link Control (RLC) layer, and the like. Data packets received by the wireless communication device may be initially associated with the MAC layer. The RLC may be a disassembly entity that performs error correction through Automatic Repeat Request (ARQ), Hybrid ARQ (HARD), and/or the like. The RLC may re-order the received data packets released by the MAC layer.

In some embodiments, the communication management module 230 may be implemented within the general-purpose processor 206. For example, the communication management module 230 may be implemented as a software application stored within the memory 214 and executed by the general-purpose processor 206. Accordingly, such embodiments can be implemented with minimal additional hardware costs. However, other embodiments relate to systems and processes implemented with dedicated hardware specifically configured for performing operations described herein with respect to the communication management module 230. For example, the communication management module 230 may be implemented as a separate processing component (i.e., separate from the general-purpose processor 206). The communication management module 230 may be coupled to the memory 214, the general processor 206, the baseband processor 216, and/or the RF resource 218 for performing the function described herein.

Hardware and/or software for the functions may be incorporated in the wireless communication device 200 during manufacturing, for example, as a part of a configuration of an original equipment manufacturer (OEM) of the wireless communication device 200. In further embodiments, such hardware and/or software may be added to the wireless communication device 200 post-manufacture, such as by installing one or more hardware devices and/or software applications onto the wireless communication device 200.

In some embodiments, the wireless communication device 200 may include, among other things, additional SIM cards, SIM interfaces, at least another RF resource associated with the additional SIM cards, and additional antennas for connecting to additional mobile networks.

In some embodiments, the wireless communication device 200 may include one or more sensors 228 connected to the general-purpose processor 206. The sensors 228 may be configured to measure one or more characteristics of the wireless communication device 200. For example, the sensors 228 may include a CPU load sensor configured to determine a current CPU load of the general-purpose processor 206. In some embodiments, the CPU load may include an overall value representing the load of the processor 206 (e.g., milliamps) or a percentage of the utilization of the processor 206 (e.g., a percentage of a maximum load the general-purpose processor is capable of processing). In some embodiments, the one or more sensors 228 includes a thermal sensor configured to determine a current thermal profile of the general-purpose processor 206. For example, the thermal sensor may detect the temperature of the general-purpose processor 206. In some embodiments, the one or more sensors 228 are incorporated or integrated within the processor 206, as opposed to being a separate unit or module.

In some embodiments, one of the first SIM 204a or the second SIM 204b may be active (e.g., receiving and transmitting data with its respective network 102 or 104, processing the data, or the like). For example, the first SIM 204a may be active (e.g., receiving data from the first mobile network 102), while the second SIM 204b is idle (e.g., not receiving data from the second mobile network 104), and vice-versa. In some embodiments, the combination of processes of an active SIM and processes of an idle SIM may jointly cause the device 200 to heat up (e.g., cause the processor 206 to undergo an increase in its thermal profile) to levels that are harmful to the wireless communication device 200 or that cause the device 200 to shut down due to a thermal event (e.g., heat generated by the device 200 surpassing a predetermined threshold).

Conventionally, the active SIM performs a “tuneaway” to the idle SIM. During the tuneaway, the active SIM may halt data communication (e.g., data reception and transmission) with its respective network, and the idle SIM may perform idle activities (e.g., searching activities, network measurement, page decoding, etc.). The tuneaway may refer to a period of time (e.g., a “gap”) that the active SIM halts data operations and the idle SIM performs idle activities. Accordingly, the longer the tuneaway gap, the more reduction in throughput of the active SIM because the active SIM will not receive data during the tuneaway gap.

Accordingly, in various embodiments, the tuneaway operation of a SIM device can be implemented as a method for reducing heat of a wireless communication device, as the processor 206 is less active during tuneaway gaps (e.g., because data for processing is not received at the active SIM). In some embodiments, a SIM device may implement a variable tuneaway during which idle activities of an idle SIM are halted, in addition to data reception of the active SIM being halted.

According to various embodiments, the present disclosure utilizes tuneaways for thermal mitigation by supporting variable length tuneaways, with the tuneaway length being proportional to the flow control (e.g., proportional to the degree of excess heat at the wireless communication device 200). According to various embodiments, since the network cannot detect this tuneaway behavior at the user equipment (UE), the network will try to retain the UE at the same configured data rate, which improves data throughput. In other words, by utilizing the methods described above, the wireless communication device can independently mitigate its heat profile, without the network itself changing any behavior (i.e., the network will continue sending data according to its normal behavior, even though the wireless communication device 200 is undergoing a thermal mitigation process).

According to various embodiments, there is provided a lossless (e.g., no loss of data transmitted to the wireless communication device 200) and network agnostic (e.g., the wireless communication device 200 undergoes a change in behavior in response to excess heat accumulation, but not the network 500) approach to quickly recover from high thermal situations at a UE. In some embodiments, a UE mitigates heating issues by dynamically throttling data rates through an adaptive Hybrid ARQ and negative acknowledgement (NACK) or no acknowledgement (Non-ACK) schemes.

According to various embodiments, when the packets are ACK'd properly on reception, the network 500 continues on with the rest of the packets, and in any given window there is a full data rate. However, in some embodiments, if the wireless communication device 200 NACKs one or more packets in the same window, the effective data rate is reduced, and the new data rate depends on the number of packets that were NACK'd in the given window, the window size, and how often the packets are transmitted by the network 500. In some embodiments, the network's ability to detect these tuneaways as being for the purpose of thermal regulation is limited (e.g., the network 500 cannot detect whether the wireless communication device 200 is performing a NACK/Non-ACK procedure due to thermal issues), so dependency on the network by the wireless communication device 200 is not needed to help mitigate thermal accumulation.

In conventional processes, tuneaways are typically designed to optimize the throughput subject to page performance. However, according to various embodiments, systems and methods are disclosed that relate to optimizing throughput while simultaneously mitigating thermal issues and improving page performance.

According to various embodiments, by manipulating the ACK/NACK/Non-ACK handshake itself, data throttling at a UE can be dynamic by being able to go into “throttle mode” and “full mode” quickly. According to some embodiments, with ACK/NACK manipulation, a UE can deterministically perform flow control within about 12 ms from the point of initiation.

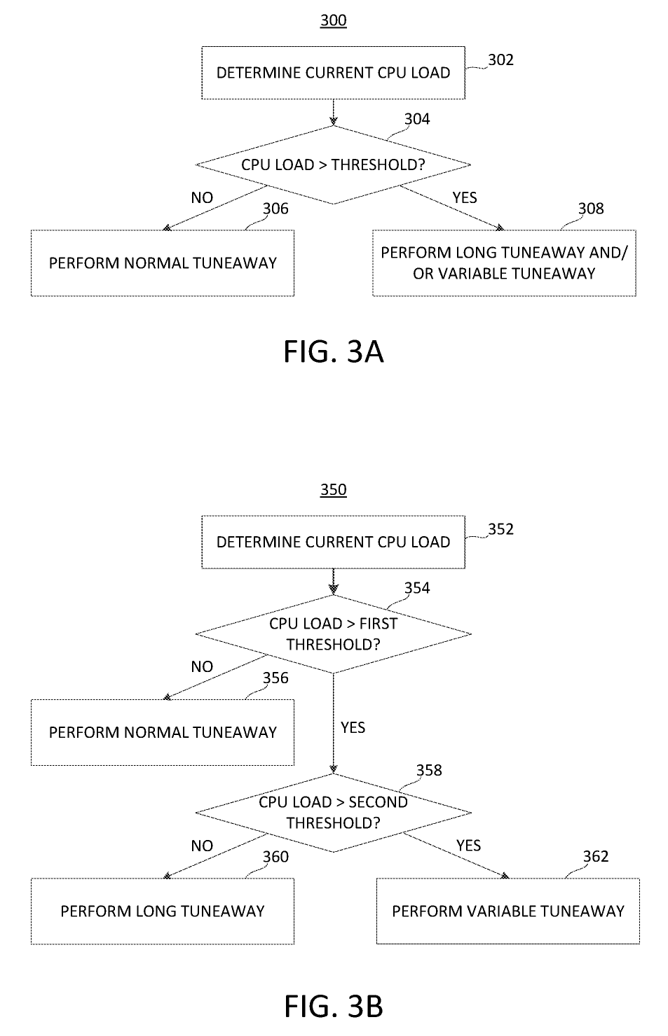

FIG. 3A is a process flowchart diagram illustrating an example of a method 300 for regulating thermal performance of the wireless communication device 200 according to various embodiments. Referring to FIGS. 1-3A, in some embodiments, the method 300 may be performed by the communication management module 230 and/or the general-purpose processor 206, and/or by any other suitable component, of the wireless communication device 200.

At block 302, the general-purpose processor 206 may determine a current CPU load of the wireless communication device 200 (e.g., a CPU load of the general-purpose processor 206). In some embodiments, the CPU load may be determined by the one or more sensors 228. In some embodiments, the CPU load may be contributed to by the SIM that is currently active and receiving and/or transmitting data, and not by the SIM that is idle or in standby. For example, the first SIM 204a may be active (e.g., receiving and processing data from the first mobile network 102), while the second SIM 204b is idle (e.g., not receiving data from the second mobile network 104). In other embodiments, the CPU load is contributed to by both the active SIM and the idle SIM, where the idle SIM may perform idle activities, such as, but not limited to, network measurements, searching (e.g., frequency band searches), paging, interference cancellation, or the like.

At block 304, the general-purpose processor 206 may determine whether the current CPU load determined at block 302 is greater than a load threshold. In some embodiments, the load threshold may be a selected threshold that is stored at the wireless communication device 200 (e.g., in the memory 214). The load threshold may be a fixed value. In further examples, the load threshold may be a variable value. For example, a fixed threshold value may be pre-stored into the memory 214 and remain at a selected value throughout operation of the wireless communication device 200. As another example, a variable load threshold value may be changed during operation of the wireless communication device 200 (e.g., automatically by the general-purpose processor 206 or manually by a user). In some embodiments, the general-purpose processor 206 accesses the current CPU load information that is detected by the one or more sensors 228 and the load threshold information stored in the memory 214 to perform the comparison.

In response to determining that the CPU load is not greater than the load threshold (304: NO), or that the CPU load is less than or equal to the load threshold, the general-purpose processor 206 may perform normal or default tuneaway operations, at block 306. During normal tuneaway operations, the active SIM may implement “quick tuneaway” gaps for page activities and “long tuneaway” gaps for non-page activities (e.g., reselection/out of service). In some embodiments, the quick tuneaway gap is about 5 milliseconds and the long tuneaway gap is about 200 milliseconds. In some embodiments, to increase the tuneaway gap, the clock cycles of the device 200 (e.g., of the general-purpose processor 206) may be reduced. In other embodiments, block 306 may be performed if the current CPU load is less than the load threshold, but not if the current CPU load is equal to the load threshold.

In response to determining that the CPU load is greater than the load threshold (304: YES), the general-purpose processor 206 may perform long tuneaway and/or variable tuneaway operations, at block 308. By way of example, at block 308, the general-purpose processor 206 may implement long tuneaway gaps in situations that would normally use a quick tuneaway gap, for example, as implemented under normal tuneaway operations at block 306. For example, whereas a quick tuneaway gap would normally be utilized for page activities, at block 308, a long tuneaway gap may be utilized for such activities (e.g., long tuneaway may be utilized for page activities, as well as the non-page activities, such that the wireless communication device 200 is configured to utilize long tuneaways only). Accordingly, by utilizing only long tuneaways, data reception at the active SIM is halted for longer periods of time, and the heat generated by the wireless communication device 200 may be reduced. In some embodiments, block 308 may be performed until the current CPU load is below or equal to the load threshold.

In some embodiments, the general-purpose processor may utilize a variable tuneaway in addition to, or instead of, long tuneaways. Further description related to variable tuneaways is provided herein.

FIG. 3B is a process flowchart diagram illustrating an example of a method 350 for regulating thermal performance of the wireless communication device 200 according to various embodiments. Referring to FIGS. 1-3B, in some embodiments, the method 350 may be performed by the communication management module 230 and/or the general-purpose processor 206, and/or by any other suitable component, of the wireless communication device 200.

At block 352, the general-purpose processor 206 may determine a current CPU load of the wireless communication device 200 (e.g., a CPU load of the general-purpose processor 206). The description above associated with the block 302 (FIG. 3A) may be applicable to the block 352.

At block 354, the general-purpose processor 206 may determine whether the current CPU load determined at block 352 is greater than a first load threshold. In some embodiments, the first load threshold may be a selected threshold that is stored at the wireless communication device 200 (e.g., in the memory 214). In some embodiments, the general-purpose processor 206 accesses the current CPU load information that is detected by the one or more sensors 228 and the first load threshold information stored in the memory 214 to perform the comparison.

In response to determining that the CPU load is not greater than the first load threshold (354: NO), or that the CPU load is less than or equal to the first load threshold, the general-purpose processor 206 may perform normal or default tuneaway operations, at block 356, as described above with respect to FIG. 3A. In other embodiments, block 356 may be performed if the current CPU load is less than the first load threshold, but not if the current CPU load is equal to the first load threshold.

In response to determining that the CPU load is greater than the first load threshold (354: YES), the general-purpose processor 206 may determine whether the current CPU load determined at block 352 is greater than a second load threshold. In some embodiments, the second load threshold may be a selected threshold that is stored at the wireless communication device 200 (e.g., in the memory 214). In some embodiments, the general-purpose processor 206 accesses the current CPU load information that is detected by the one or more sensors 228 and the second load threshold information stored in the memory 214 to perform the comparison. In some embodiments, the second load threshold has a different value from that of the first load threshold. In particular embodiments, the value of the second load threshold is greater than that of the first load threshold.

In response to determining that the CPU load is not greater than the second load threshold (358: NO), or that the CPU load is less than or equal to the second load threshold, the general-purpose processor 206 may perform long tuneaway operations, in lieu of quick tuneaway operations, at block 356, as described above with respect to FIG. 3A. In other embodiments, block 358 may be performed if the current CPU load is less than the second load threshold, but not if the current CPU load is equal to the second load threshold.

In response to determining that the CPU load is greater than the second load threshold (358: YES), the general-purpose processor 206 may perform variable tuneaway operations, at block 362. In some embodiments, the variable operations are performed in addition to the long tuneaway operations of block 360. Further description related to variable tuneaways is provided herein.

Accordingly, in some embodiments, a multi-tiered solution is provided for regulating and mitigating heat generated at a wireless communication device. In some embodiments, a first and second load threshold are provided, with a value of the second threshold being larger than a value of the first threshold. In addition, if the CPU load is below the first threshold, the processor 206 may perform normal tuneaway operations (e.g., both quick and long tuneaway). If the CPU load is determined to be between the first threshold and the second threshold, the processor 206 may perform an intermediary solution to respond to the relatively minor heat generation (e.g., by performing exclusively long tuneaway operations). However, if the wireless communication device 200 is experiencing relatively severe heat generation, that is, the CPU load is greater than the second load threshold, then the processor 206 may respond more drastically (e.g., by performing variable tuneaway in addition to the long tuneaway).

In some embodiments, the wireless communication device 200 communicates with a network (e.g., first mobile network 102 or second mobile network 104). The network that communicates with the wireless communication device 200 may provide High Speed Packet Access (HSPA), which may be an enhancement to WCDMA and UMTS cellular networks. The network may provide Hybrid Automatic Repeat Request capabilities (Hybrid ARQ). In Hybrid ARQ, retransmission of data packets to the device 200 is possible, when the data packets are indicated to have errors (e.g., a signal indicating an error may be sent from the device 200 to the network so that the data packet may be retransmitted). For example, the device 200 may receive a data packet, decode it, and report back whether the data packet has errors or is acceptable to the network after reception of the packet.

In some embodiments, the variable tuneaways are gaps during which one or more Negative Acknowledgment (NACK) signals are sent to the network by the active SIM in response to a data packet received by the active SIM from the network. Alternatively, the variable tuneaways are gaps during which no acknowledgement (ACK) signal is sent (non-ACK) by the active SIM to the network in response to a data packet received by the active SIM from the network. In some embodiments, such as those including an HSPA network, a NACK signal typically indicates an error associated with a received data packet, while an ACK signal typically indicates that the received data packet is acceptable. The number of NACK signals or number of data packets not ACK'd by the active SIM may determine the length of the variable tuneaway gap.

In some embodiments, the length of the variable tuneaway gap is based on (e.g., proportional to) the thermal state of the wireless communication device 200. For example, the variable tuneaway gap length may be proportional to the current CPU load. In addition, during the variable tuneaways, the wireless communication device 200 may shut down both the data activities of the active SIM and the idle activities of the idle SIM (e.g., measurements, searches, etc.), such that the wireless communication device 200 is substantially inactive during the variable tuneaway gap.

Accordingly, various embodiments are capable of dynamically achieving CPU load throttling through an adaptive Hybrid ARQ NACK or non-ACK scheme. As such, in some embodiments, the data rate of the wireless communication device 200 may be a factor of the number of ACKs, NACKs, or non-ACKs received in a session. In addition, forcing adaptive data retransmission from the network through the implemented variable number of NACKs, based on a determined heavy CPU load, provides a window for the wireless communication device 200 to recover from overheating caused by the excessive CPU load relatively quickly. Similarly, in some embodiments, not transmitting anything by the wireless communication device will be considered as a non-ACK by the network.

In various embodiments, when data packets are ACK'd properly by the device 200, the network may continue with the rest of the data packets upon reception of the ACK from the device 200. However, in some embodiments, if the wireless communication device 200 NACKs a few packets in a same window, then the effective data rate of the wireless communication device 200 may be reduced. Accordingly, the new data rate may depend on the number of packets that are NACK'd in a given window, the window size, and how often the packets are transmitted by the network.

Accordingly, in some embodiments a data throttling mechanism is provided that can reduce the data rate of a UE quickly, and thus provide thermal mitigation of the UE. Some embodiments are based on the ACK/NACK that a UE sends for every data packet it receives. In HSPA, Hybrid ARQ processes are configured for re-transmissions and the ACK/NACK for every downlink block is sent to the network. The network may re-transmit a block over the same Hybrid ARQ process if a NACK is detected or if the network is not able to receive anything within a predefined time (non-ACK). Due to inherent HSPA timelines, any re-transmission may happen after five intervals or sub-frames.

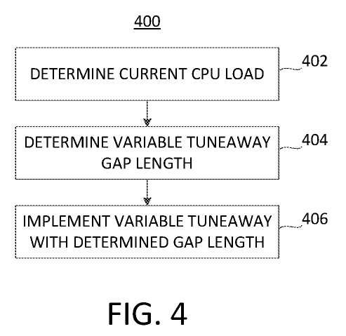

FIG. 4 is a process flowchart diagram illustrating an example of a method 400 for implementing variable tuneaway at the wireless communication device 200 according to various embodiments. Referring to FIGS. 1-4, in some embodiments, the method 400 may be performed by the communication management module 230 and/or the general-purpose processor 206, and/or by any other suitable component, of the wireless communication device 200.

At block 402, the general-purpose processor 206 may determine a current CPU load of the wireless communication device 200 (e.g., of the general-purpose processor 206). The description above associated with the block 302 (FIG. 3A) may be applicable to the block 402.

At block 404, the general-purpose processor 206 may determine a variable tuneaway gap length. In some embodiments, the variable tuneaway gap length is based on the determined CPU load. In some embodiments, the variable tuneaway gap length is proportional to the CPU load. In particular embodiments, the variable gap length may be based on (e.g., proportional to) the amount of CPU load that exceeds the load threshold described above in connection with FIG. 3A, or that exceeds the second load threshold described above in connection with FIG. 3B. For example, in particular embodiments, the gap length may be increased by one millisecond for every percentage point the CPU load exceeds the load threshold.

At block 406, the general-purpose processor 206 may implement the variable tuneaway with the gap length determined at block 404. During the variable tuneaway, in some embodiments, the general-purpose processor 206 may halt data operations (e.g., reception and transmission) at the active SIM. In further embodiments, the general-purpose processor 206 may halt idle operations at the idle SIM as well during the variable tuneaway. As such, due to the general-purpose processor 206 halting operations at the first SIM 204a and at the second SIM 204b, the wireless communication device 200 is able to cool down to a desired level and resume data activities once the temperature has lowered to the desired level (e.g., when the CPU load is reduced to below the load threshold).

In some embodiments, because the data operations of the active SIM is halted, the wireless communication device 200 during the variable tuneaway will not transmit any ACKs in response to data packets transmitted by the active network to the wireless communication device 200. However, in some embodiments, because the network automatically retransmits data packets that are not ACK'd (e.g., in a network using Hybrid ARQ), there will be no loss of data rate, as the wireless communication device 200 will subsequently receive the non-ACK'd data packet after exiting the variable tuneaway. Therefore, the wireless communication device 200 will eventually receive the same data packet that was non-ACK'd during the variable tuneaway. Accordingly, in some embodiments, the method 400 may be a non-ACK-based solution (by passively not ACK'ing received data packets), as opposed to a NACK-based solution (by actively sending NACKs in response to received packets). NACK-based solutions are described further below.

In some embodiments, a maximum variable tuneaway gap length value may be provided at the wireless communication device 200 (e.g., stored in the memory 214). The maximum variable tuneaway gap length value may dictate the maximum time that a variable tuneaway gap length may extend (e.g., as determined at block 404), regardless of the CPU load determined at block 402. Accordingly, in some embodiments, the variable tuneaway gap length may be capped such that a radio link failure does not occur at the wireless communication device 200 during a variable tuneaway.

Accordingly, in various embodiments, a wireless communication device will open the tuneaway gaps on an active SIM and save the processing power (e.g., decrease CPU load) by not doing anything during these gaps. In some embodiments, gap length is proportional to the amount of flow control needed, as a network will consider this as a non-ACK situation. In some embodiments, there will be no loss of data rate when the UE comes out of the tuneaway gap, as the resources will be intact from the network side (e.g., retransmission of the data that was non-ACK'd may occur).

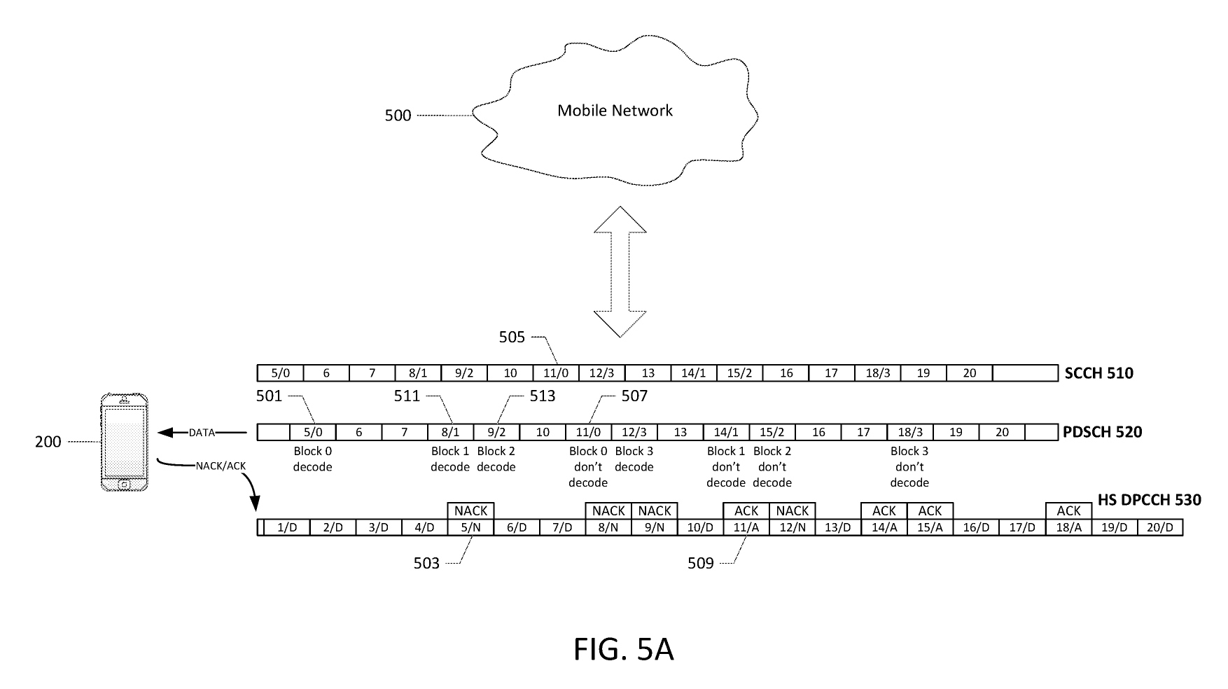

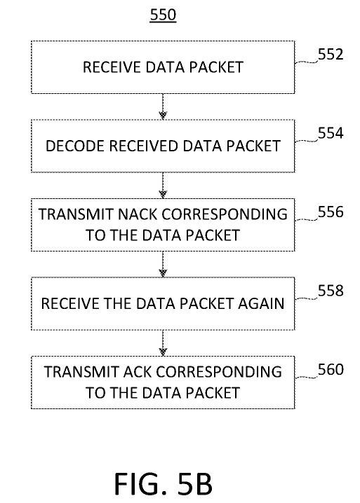

FIG. 5A is a block diagram illustrating transmission of data packets between a network 500 and the wireless communication device 200. Referring to FIG. 5A, a NACK-based solution may be implemented for inducing variable tuneaways at the wireless communication device 200. The network 500 may be an HSPA network that provides Hybrid ARQ capabilities, which may be the same as or similar to the first mobile network 102 (FIG. 1) and the second mobile network 104 (FIG. 1). In some embodiments, the network 500 sends and receives information to and from the wireless communication device 200 during intervals or sub-frames 1, 2, 3, 4, 5 . . . n. In some embodiments, the network 500 communicates with the wireless communication device 200 via one or more channels (e.g., three channels 510, 520, and 530). In other words, in some embodiments, the network 500 sends and receives data via three channels 510, 520, and 530, which are also in communication with the wireless communication device 200. In particular embodiments, as shown in FIG. 5A, the one or more channels include a Signaling Control Channel (SCCH) 510, a Physical Downlink Shared Channel (PDSCH) 520, and a High Speed Dedicated Physical Control Channel (HS-DPCCH) 530.

The SCCH 510 may be utilized to signal the scheduling to the users (e.g., the wireless communication devices). In some embodiments, the SCCH 510 carries information including a UE identity to allow specific addressing of individual UEs, the Hybrid ARQ, and a Transport Format and Resource Indicator (TFRI) to identify a scheduled resource and transmission format. In some embodiments, the PDSCH 520 is a data transport channel. In some embodiments, the HS-DPCCH 530 is utilized to provide feedback to the scheduler (e.g., SCCH 510) and is located in the uplink. In particular embodiments, the HS-DPCCH 530 channel carries information including Hybrid ARQ ACK and NACK information (e.g., received from the wireless communication device 200), which the HS-DPCCH 530 may use to request resending of data packets that have not been successfully received by the wireless communication device 200 (e.g., as indicated by a NACK or a non-ACK).

Accordingly, FIG. 5A illustrates a wireless communication device 200 that transmits NACKs and ACKs to achieve a variable tuneaway to mitigate heat accumulation at the wireless communication device 200. By way of example, the wireless communication device 200 receives data from the PDSCH 520 and transmits a NACK or ACK corresponding to the received data to the HS-DPCCH 530, as shown by the Data and the NACK/ACK arrows in FIG. 5A.

In some embodiments, the wireless communication device 200 receives data block 0 at interval 5 (501 in FIG. 5A). In response to the received data block 0, the wireless communication device 200 transmits a NACK signal to the HS-DPCCH 530 (503 in FIG. 5A). However, even though the wireless communication device 200 has NACK'd data block 0 of interval 5, the wireless communication device 200 may still be configured to decode the data block 0 so that decoding of data block 0 is not needed after the subsequent retransmission of data block 0 (described below).

In some embodiments, after the network 500 receives the NACK corresponding to interval 5 via the HS-PDSCH 530, the network schedules the retransmission of data block 0 via SCCH 510. However, due to inherent delay between the network 500 and the wireless communication device 200, the network 500 may not schedule a retransmission of data block 0 via SCCH 510 until a particular number of intervals after the NACK'd interval. For example, because data block 0 associated with interval 5 was NACK'd, the network 500 may not schedule, via SCCH 510, retransmission of data block 0 until interval 11, which is six intervals after interval 5.

Accordingly, in some embodiments, the network 500 reschedules data block 0 via SCCH 510 for interval 11 (505 in FIG. 5A), and the network 500 retransmits the data block 0 during interval 11 via PDSCH 520 to the wireless communication device 200 (507 in FIG. 5A). After receiving the data block 0 the second time during interval 11, the wireless communication device 200 may transmit an ACK signal to network 500 via the HS-DPCCH 530 confirming successful receipt of data block 0. Furthermore, because the wireless communication device 200 already decoded data block 0 after initial reception during interval 5, the wireless communication device 200 does not need to decode data block 0 again. In some embodiments, because data block 0 was ACK'd after retransmission, the network 500 does not retransmit the data block 0 again.

In some embodiments, the network 500 sends additional data blocks during the time period between the first received NACK and the retransmission of data block 0 because of the inherent delay. For example, because the network 500 schedules retransmission six intervals after the NACK'd interval, the network 500 may send new data blocks before the retransmission, during the six interval delay. As an example, network 500 may transmit data blocks 1 and 2 during intervals 8 and 9, respectively (511 and 513, respectively, in FIG. 5A), during the six interval delay after the wireless communication device 200 NACK'd data block 0 at interval 5.

In some embodiments, the wireless communication device 200 also NACKs (and decodes) data blocks 1 and 2, as done with data block 0. Accordingly, the network 500 may retransmit data blocks 1 and 2 six intervals after intervals 8 and 9, respectively (e.g., during intervals 14 and 15, respectively), at which times the wireless communication device 200 may ACK the retransmissions of data blocks 1 and 2. As such, the wireless communication device 200 may continue NACK'ing data transmissions to induce a variable tuneaway gap for mitigating thermal issues at the wireless communication device 200.

Accordingly, with the above-described process of NACK'ing a data packet, decoding the data packet, and subsequently ACK'ing the retransmitted data packet, the data rate of the wireless communication device 200 may be reduced by 50%, providing time for the wireless communication device 200 to reduce heat accumulation. In other embodiments, the wireless communication device 200 does not decode a data packet before NACK'ing the data packet, but decodes the data packet after ACK'ing the packet (e.g., after the retransmission of the data packet but not after the initial transmission).

FIG. 5B is a process flowchart diagram illustrating an example of a method 550 for implementing variable or variable tuneaway at a wireless communication device 200 according to various embodiments. Referring to both FIGS. 5A and 5B, in some embodiments, the method 550 may be performed by the communication management module 230 (FIG. 2) and/or the general-purpose processor 206 (FIG. 2), and/or by any other suitable component, of the wireless communication device 200 (FIG. 2).

At block 552, the general-purpose processor 206 may receive a data packet. The data packet may be received from the network 500 (FIG. 5A). The data packet may be associated with an interval of time (e.g., a first interval). The data packet may be transmitted over the HS-DPCCH 530 (FIG. 5A) at 501. The data packet may be received by a SIM at the wireless communication device 200.

At block 554, the general-purpose processor 206 may decode the received data packet, as shown at 501 in FIG. 5A. The received data packet may be decoded after the wireless communication device 200 receives the data packet during the first interval (501 shown in FIG. 5A).

At block 556, the general-purpose processor 206 may transmit a NACK signal corresponding to the data packet. The data packet may be NACK'd by the wireless communication device 200 at the first interval during which the data packet was received. For example, the NACK signal may be transmitted from the wireless communication device 200 to the network 500 via the HS-DPCCH 530 (503 shown in FIG. 5A).

At block 558, the general-purpose processor 206 may receive the data packet again. The wireless communication device 200 may receive the same data packet previously received at the first interval during a second interval subsequent to the first interval. For example, as shown in FIG. 5A, the second interval (505—interval 11) may be six intervals after the first interval (501—interval 5). Because the data packet was previously decoded by the wireless communication device 200 after the initial reception of the data packet, the same data packet may not be decoded during the second interval.

At block 560, the general-purpose processor 206 may transmit an ACK signal corresponding to the retransmitted data packet. The retransmission of the data packet may be ACK'd by the wireless communication device 200 at the second interval during which the data packet was re-received. For example, the ACK signal may be transmitted from the wireless communication device 200 to the network 500 via the HS-DPCCH 530 (509 shown in FIG. 5A).

According to some embodiments, systems and methods are configured to decode each received packet (e.g., 511 shown in FIG. 5A). When a new packet is received, the new packet may be NACK'd by the wireless communication device to the network 500. When the same packet is re-transmitted, the wireless communication device 200 may ignore decoding and processing the packet, but transmit an ACK this time. Accordingly, the data rate may be reduced by 50%. Furthermore, in some embodiments, the wireless communication device 200 may not miss out on any data blocks, as the wireless communication device 200 may decode the data packets and determine when a new block is transmitted.

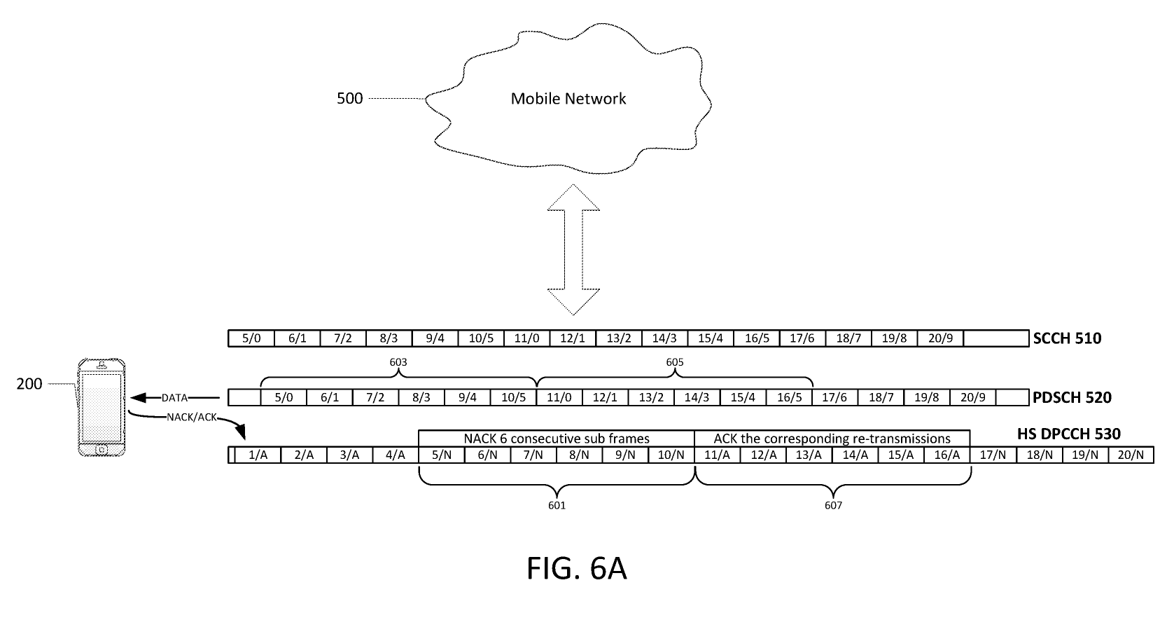

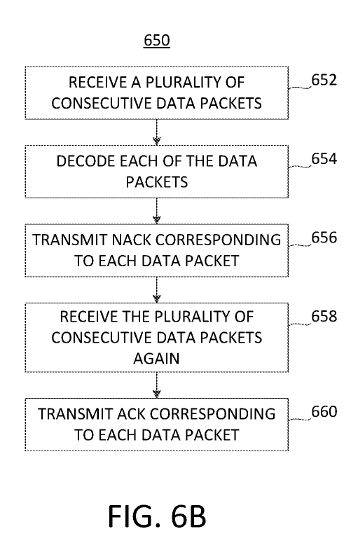

FIG. 6A is a block diagram illustrating transmission of data packets between the network 500 and the wireless communication device 200. Referring to FIG. 6A, another NACK-based solution may be implemented for inducing variable tuneaways at the wireless communication device 200. In some embodiments, the wireless communication device 200 may NACK a plurality of consecutive data blocks during corresponding consecutive intervals.

For example, in some embodiments, the wireless communication device 200 NACKs six consecutive intervals or sub-frames 5, 6, 7, 8, 9, and 10 (at 601) corresponding to data blocks 0, 1, 2, 3, 4, and 5 (at 603), respectively. In some embodiments, the wireless communication device 200 NACKs six consecutive intervals because of the inherent delay that causes retransmission of a NACK'd data block after six intervals, as discussed above with respect to FIGS. 5A and 5B. However, in other embodiments, the wireless communication device 200 may NACK any suitable number of consecutive data blocks at consecutive intervals, such as, but not limited to, less than six, more than six, some multiple of six, or the like. In some embodiments, the wireless communication device 200 may decode each of the data blocks after reception and before NACK'ing the respective data blocks.

After NACK'ing the data blocks 0, 1, 2, 3, 4, and 5 associated with intervals 5, 6, 7, 8, 9, and 10, respectively (at 601), the network 500 begins retransmission of data blocks 0, 1, 2, 3, 4, and 5 at intervals 11, 12, 13, 14, 15, and 16, respectively (at 605). After receiving each retransmission, in some embodiments, the wireless communication device 200 ACKs each of the retransmitted data packets (at 607).

FIG. 6B is a process flowchart diagram illustrating an example of a method 650 for implementing variable or variable tuneaway at the wireless communication device 200 according to various embodiments. Referring to FIG. 6B, in some embodiments, the method 650 may be performed by the communication management module 230 and/or the general-purpose processor 206, and/or by any other suitable component, of the wireless communication device 200.

At block 652, the general-purpose processor 206 may receive a plurality of consecutive data packets (603 shown in FIG. 6A). The data packets may be received from the network 500. Each of the data packets may be associated with an interval of time or a sub-frame (e.g., a first interval, a second interval, etc.). The data packets may be transmitted by the network 500 via the PDSCH 520. The data packets may be received by a SIM at the wireless communication device 200. In some embodiments, a first data packet (e.g., data packet 0 in FIG. 6A) is associated with a first interval (e.g., interval 5 in FIG. 6A), a second data packet (e.g., data packet 1 in FIG. 6A) is associated with a second interval (e.g., interval 6 in FIG. 6A), and so on. The first interval and the second interval may be consecutive intervals. The data packets may be received across six separate and consecutive intervals.

At block 654, the general-purpose processor 206 may decode each of the received data packets. Each of the received data packets may be decoded after the wireless communication device 200 receives a respective data packet. For example, a first data packet (e.g., data packet 0 in FIG. 6A) may be received during a first interval (e.g., interval 5 in FIG. 6A) and may be decoded after reception of the first data packet, and then a second data packet (e.g., data packet 1 in FIG. 6A) may be received during a second interval (e.g., interval 6 in FIG. 6A) and may be decoded after reception of the second data packet, and so on. The first and second intervals may be consecutive intervals.

At block 656, the general-purpose processor 206 may transmit a NACK signal corresponding to each of the data packets (601 shown in FIG. 6A). A first data packet (e.g., data packet 0 in FIG. 6A) may be NACK'd by the wireless communication device 200 at the first interval (e.g., interval 5 in FIG. 6A) during which the first data packet was received, a second data packet (e.g., data packet 1 in FIG. 6A) may be NACK'd by the wireless communication device 200 at the second interval (e.g., interval 6 in FIG. 6A) during which the second data packet was received, and so on. The NACK signals may be transmitted from the wireless communication device 200 to the network 500 via the HS-DPCCH 530.

At block 658, the general-purpose processor 206 may receive each of the plurality of consecutive data packets again (605 shown in FIG. 6A). The wireless communication device 200 may receive the same data packet (e.g., data packet 0 shown in FIG. 6A) previously received at the first interval (e.g., interval 5 shown in FIG. 6A) during an interval subsequent to the first interval (e.g., interval 11 shown in FIG. 6A), the subsequent interval being after the plurality of consecutive intervals that were NACK'd by the wireless communication device 200 (601 shown in FIG. 6A). The subsequent interval may be six intervals after the first interval, and so on. Because the data packets were previously decoded by the wireless communication device 200 after the initial reception of the data packets, the same data packets may not be decoded during the subsequent interval.

At block 660, the general-purpose processor 206 may transmit an ACK signal corresponding to the retransmitted data packets (607 shown in FIG. 6A). The retransmission of the data packets may be ACK'd by the wireless communication device 200 at the subsequent intervals during which the data packets are re-received. The ACK signal may be transmitted from the wireless communication device 200 to the network 500 via the HS-DPCCH 530.

According to some embodiments, the wireless communication device 200 may ignore and decode every alternate six intervals by correspondingly sending NACKs and ACKs in the alternate intervals. In some embodiments, since a re-transmission is guaranteed to come after the sixth interval, if any block was missed out in the “OFF” period, the missed block can be decoded in the “ON” period. Persons skilled in the art will appreciate that any suitable number of intervals may be used by the network to re-transmit.

According to various embodiments, although the systems and methods described herein have been disclosed with respect to a multi-SIM wireless communication device, the present disclosure is equally applicable to single-SIM wireless communication devices. For example, the methods and systems illustrated in FIGS. 3A, 3B, 4, 5A, 5B, 6A, and 6B may be performed at a single-SIM wireless communication device.

Persons skilled in the art will appreciate that the embodiments described with respect to FIG. 4 is a simple implementation, while the embodiments described with respect to FIGS. 5A-6B includes more technicality to ensure a device will not miss a packet to decode, as the SCCH is monitored to check for new transmissions.

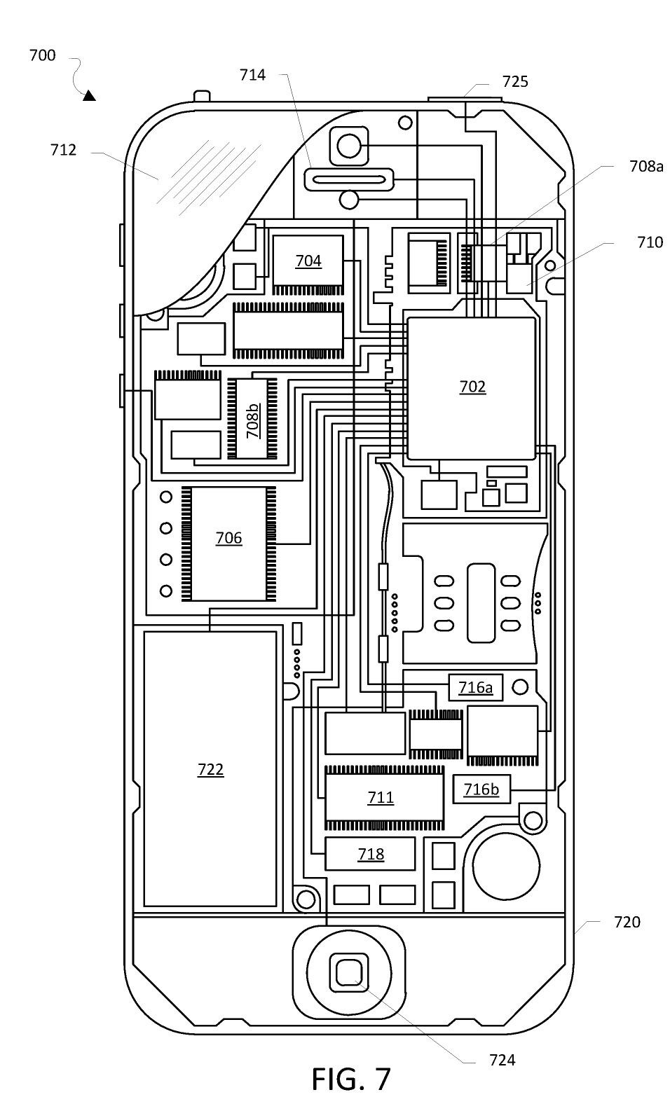

The various embodiments may be implemented in any of a variety of wireless communication devices 110 and 200, an example of which is illustrated in FIG. 7, as wireless communication device 700. As such, the wireless communication device 700 may implement the process and/or the apparatus of FIGS. 1-6B, as described herein.

With reference to FIGS. 1-7, the wireless communication device 700 may include a processor 702 coupled to a touchscreen controller 704 and an internal memory 706. The processor 702 may be one or more multi-core integrated circuits designated for general or specific processing tasks. The memory 706 may be volatile or non-volatile memory, and may also be secure and/or encrypted memory, or unsecure and/or unencrypted memory, or any combination thereof. The touchscreen controller 704 and the processor 702 may also be coupled to a touchscreen panel 712, such as a resistive-sensing touchscreen, capacitive-sensing touchscreen, infrared sensing touchscreen, etc. Additionally, the display of the wireless communication device 700 need not have touch screen capability.

The wireless communication device 700 may have one or more cellular network transceivers 708a, 708b coupled to the processor 702 and to at least one antenna 710 and configured for sending and receiving cellular communications. The transceivers 708a, 708b and antenna 710 may be used with the above-mentioned circuitry to implement the various embodiment methods. The cellular network transceivers 708a, 708b may be the RF resource 218. The antenna 710 may be the antenna 220. The wireless communication device 700 may include two or more SIM cards 716a, 716b, corresponding to SIM-1 204a (the first SIM) and SIM-2 204b (the second SIM), coupled to the transceivers 708a, 708b and/or the processor 702. The wireless communication device 700 may include a cellular network wireless modem chip 711 (e.g., the baseband modem processor 216) that enables communication via at least one cellular network and is coupled to the processor 702.

The wireless communication device 700 may include a peripheral device connection interface 718 coupled to the processor 702. The peripheral device connection interface 718 may be singularly configured to accept one type of connection, or multiply configured to accept various types of physical and communication connections, common or proprietary, such as USB, FireWire, Thunderbolt, or PCIe. The peripheral device connection interface 718 may also be coupled to a similarly configured peripheral device connection port (not shown).

The wireless communication device 700 may also include speakers 714 for providing audio outputs. The wireless communication device 700 may also include a housing 720, constructed of a plastic, metal, or a combination of materials, for containing all or some of the components discussed herein. The wireless communication device 700 may include a power source 722 coupled to the processor 702, such as a disposable or rechargeable battery. The rechargeable battery may also be coupled to a peripheral device connection port (not shown) to receive a charging current from a source external to the wireless communication device 700. The wireless communication device 700 may also include a physical button 724 for receiving user inputs. The wireless communication device 700 may also include a power button 726 for turning the wireless communication device 700 on and off.

The various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment.

The foregoing method descriptions and the process flow diagrams are provided merely as illustrative examples and are not intended to require or imply that the steps of various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present embodiments.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In some exemplary embodiments, the functions described may be implemented in hardware, software, firmware, or any combination thereof. If implemented in software, the functions may be stored as one or more instructions or code on a non-transitory computer-readable storage medium or non-transitory processor-readable storage medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the present embodiments. Various modifications to these embodiments will be readily apparent to those skilled in the art, and the generic principles defined herein may be applied to some embodiments without departing from the spirit or scope of the embodiments. Thus, the present embodiments are not intended to be limited to the embodiments shown herein but is to be accorded the widest scope consistent with the following claims and the principles and novel features disclosed herein.

What is claimed is:

1. A method for a wireless communication device having at least one Subscriber Identity Module (SIM) associated with a subscription to manage communications over the subscription, the method comprising:
determining a value of a computer processing unit (CPU) load of the wireless communication device, wherein the CPU load is based on data operations of the at least one SIM and contributing to a thermal state of the wireless communication device;
determining whether the value of the CPU load is greater than a load threshold; and
in response to determining that the value of the CPU load is greater than the load threshold, performing a variable tuneaway at the at least one SIM during which the at least one SIM is configured to halt the data operations, wherein a length of the variable tuneaway is based on the value of the CPU load.

2. The method of claim 1, wherein the length of the variable tuneaway is proportional to the value of the CPU load.

3. The method of claim 1, further comprising:
receiving a data packet during a first interval; and
in response to determining that the value of the CPU load is greater than the load threshold, transmitting a negative acknowledgement (NACK) signal corresponding to the data packet received during the first interval.

4. The method of claim 3, further comprising, decoding the data packet received during the first interval before transmitting the NACK signal.

5. The method of claim 3, further comprising:
receiving the data packet during a second interval, the data packet received during the second interval being the same as the data packet received during the first interval; and
in response to receiving the data packet during the second interval, transmitting an acknowledgement (ACK) signal corresponding to the data packet received during the second interval.

6. The method of claim 1, further comprising:
receiving a plurality of consecutive data packets during a plurality of consecutive respective intervals; and
in response to determining that the value of the CPU load is greater than the load threshold, transmitting a plurality of consecutive negative acknowledgement (NACK) signals corresponding to the plurality of the consecutive respective intervals.

7. The method of claim 6, further comprising, decoding each of the consecutive data packets received during the plurality of consecutive respective intervals before transmitting the plurality of consecutive NACK signals.

8. The method of claim 6, further comprising:
receiving the plurality of consecutive data packets during a plurality of subsequent consecutive respective intervals, the plurality of consecutive respective intervals being different from the plurality of subsequent consecutive respective intervals; and
in response to receiving the plurality of consecutive data packets during the plurality of subsequent consecutive respective intervals, transmitting a plurality of consecutive acknowledgement (ACK) signals corresponding to the plurality of subsequent consecutive respective intervals.

9. The method of claim 6, wherein a number of the plurality of consecutive NACK signals equals a number of the plurality of consecutive data packets received during the plurality of consecutive respective intervals.

10. The method of claim 6, wherein:
the receiving the plurality of consecutive data packets during the plurality of consecutive respective intervals comprises receiving a predetermined number of consecutive data packets during the predetermined number of consecutive respective intervals; and
the transmitting the plurality of consecutive NACK signals comprises transmitting the predetermined number of consecutive NACK signals corresponding to the predetermined number of consecutive respective intervals.

11. The method of claim 1, wherein the at least one SIM comprises an active SIM and an idle SIM, and the CPU load is based on the data operations of the active SIM and idle operations of the idle SIM.

12. The method of claim 1, wherein the load threshold is a fixed value or a variable value.

13. A wireless communication device, comprising:
a processor connected to at least one Subscriber Identity Module (SIM) associated with a subscription, the processor configured to:
determine a value of a computer processing unit (CPU) load of the wireless communication device, wherein the CPU load is based on data operations of the at least one SIM and contributing to a thermal state of the wireless communication device;
determine whether the value of the CPU load is greater than a load threshold; and
in response to determining that the value of the CPU load is greater than the load threshold, performing a variable tuneaway at the at least one SIM during which the at least one SIM is configured to halt the data operations, wherein a length of the variable tuneaway is based on the value of the CPU load.

14. The device of claim 13, wherein the length of the variable tuneaway is proportional to the value of the CPU load.

15. The device of claim 13, wherein the processor is further configured to:
receive a data packet during a first interval; and
in response to determining that the value of the CPU load is greater than the load threshold, transmit a negative acknowledgement (NACK) signal corresponding to the data packet received during the first interval.

16. The device of claim 15, wherein the processor is further configured to:
receive the data packet during a second interval, the data packet received during the second interval being the same as the data packet received during the first interval; and
in response to receiving the data packet during the second interval, transmit an acknowledgement (ACK) signal corresponding to the data packet received during the second interval.

17. The device of claim 13, wherein the processor is further configured to:
receive a plurality of consecutive data packets during a plurality of consecutive respective intervals; and
in response to determining that the value of the CPU load is greater than the load threshold, transmit a plurality of consecutive negative acknowledgement (NACK) signals corresponding to the plurality of the consecutive respective intervals.

18. The device of claim 17, wherein the processor is further configured to:
receive the plurality of consecutive data packets during a plurality of subsequent consecutive respective intervals, the plurality of consecutive respective intervals being different from the plurality of subsequent consecutive respective intervals; and
in response to receiving the plurality of consecutive data packets during the plurality of subsequent consecutive respective intervals, transmit a plurality of consecutive acknowledgement (ACK) signals corresponding to the plurality of subsequent consecutive respective intervals.

19. An apparatus for a wireless communication device having at least one Subscriber Identity Module (SIM) associated with a subscription to manage communications over the subscription, the apparatus comprising:
means for determining a value of a computer processing unit (CPU) load of the wireless communication device, wherein the CPU load is based on data operations of the at least one SIM and contributing to a thermal state of the wireless communication device;
means for determining whether the value of the CPU load is greater than a load threshold; and
in response to determining that the value of the CPU load is greater than the load threshold, means for performing a variable tuneaway at the at least one SIM during which the at least one SIM is configured to halt the data operations, wherein a length of the variable tuneaway is based on the value of the CPU load.

20. A non-transient computer-readable medium comprising program instruction that, when executed, causes a computer to:
determine a value of a computer processing unit (CPU) load of the wireless communication device, wherein the CPU load is based on data operations of the at least one SIM and contributing to a thermal state of the wireless communication device;
determine whether the value of the CPU load is greater than a load threshold; and
in response to determining that the value of the CPU load is greater than the load threshold, performing a variable tuneaway at the at least one SIM during which the at least one SIM is configured to halt the data operations, wherein a length of the variable tuneaway is based on the value of the CPU load.
